(19) United States
(12) Patent Application Publication
(10) Pub. No.: US 2015/0356510 A1
(43) Pub. Date: Dec. 10, 2015

(54) METHOD AND SYSTEM FOR FULFILLING LABOR REQUIREMENTS

(71) Applicant: Michael A. Campesi, White Castle, LA (US)

(72) Inventors: Michael A. Campesi, White Castle, LA (US); Shawn O'Daniels, New Orleans, LA (US)

(73) Assignee: Michael A. Campesi

(21) Appl. No.: 14/298,619

(22) Filed: Jun. 6, 2014

(51) Int. Cl. G06Q 10/10

(52) U.S. Cl. CPC G06Q 10/1053

(57) ABSTRACT

A system and method for matching potential employees with potential employers over a network. Potential employees sign up for a job notification service and receive information about job openings, including temporary job positions, on their electronic communications devices, which may include a smart phone, a tablet, a laptop, etc. When signing up for the service, the employees generate their Employee Profiles, which contain information about the potential employees certifications, licensing, availability for the job assignment, readiness to travel and other requested information. An employer, when signing up for the service, selects to participate in an open pool or a restricted, closed pool, where only this employer has access to potential employees and job postings of the employee. The server compares the employee profile data with job postings and sends a notification to the employees about available jobs, while also sends to the employer a list of possible job candidates. The employee and the employer can accept or decline the offers. An incentive program may be offered to employees creating an account within the network.

### BACKGROUND OF THE INVENTION

The instant invention relates to the field of personnel staffing, and more particularly to a system for coordinating staffing requirements in a temporary labor market. The invention is particularly useful in matching employees and/or temporary workers or contract workers with employers having specific requirements for filling temporary positions.

The staffing of industrial companies, such as construction, oil and gas, and others, to meet the needs of particular projects is a complex and challenging problem. Industrial project managers and construction contractors need to have qualified personnel to complete projects on time and within budget. Similarly, when bidding on a construction project, the contractors need to take into account availability of skilled tradesmen, their experience, certifications, licensure and qualifications. Many large construction companies have permanent employees, as a result of which preparing a bidding tender or manage the undertaking of a construction project is almost routine. However, for small companies, preparation of a cost estimate becomes complicated as the small company may not have sufficient permanent labor force in its employ.

Temporary staff may be allocated to support these situations. However such temporary staff may be unavailable if the contractor does not have access to a labor market database and has no means of determining availability of experienced workers in a given location. To address the problem, there exist a variety of construction employment agencies, which specialize in providing commercial and industrial construction contractors temporary labor staffing. The employment agencies usually know the local market; they know construction workers in their worksite area. Still, many companies have a need to streamline labor staffing process to focus on finding laborers who are qualified for the project. These companies prefer to find skilled labor tradesmen and match them to the requirements of the project when estimating their bid tenders.

Temporary employment agencies assist human resources departments in matching the companies' needs with job applicants in a specific field. However, the process is often time-consuming and less than efficient. One of the solutions to the problem is disclosed in U.S. Patent application publication No. 2002/0123921 filed by Frazier entitled “System and Method for Fulfilling Staffing Requests.” The application discloses a system and method for fulfilling job and product request from customers and employers. The system includes an employee input terminal, which communicates with a database, a qualifications database, and a broadcasting module, all of which allows the transfer and saving of data between terminal and computer system. One preferred embodiment discloses a method, which includes the steps of a prospective employee requesting an initial job application from the computing system through the employee input terminal and the computing system providing a detailed application to the prospective employee. The application may include information deemed necessary to match the prospective employee's skills with job openings. The prospective employee fills out the received application and submits the application and is either accepted or denied after evaluation. If accepted, the prospective employee creates a work profile. The employer, after being accepted through a vetting process, submits a job notice request to the computing system. The computing system receives and stores the request data in the requirements database and automatically scans all employee records located in the qualifications database. The computing system then generates a list of all employees matching the requirements submitted by the employer and notifies all matching employee candidates of the job notice request via the employee candidate's preferred mode of communication. The employee candidate may accept, reject, or ignore the job notice request. An employer records employee's start and stop times and sends them to the computing system along with any discrepancies.

While the system of Frazier's application may work well in certain environments, there is a need for a streamlined system and method of creating a multi-faceted database of job applicants and matching the job applicants' skills with labor requirements in the current market.

### SUMMARY OF THE INVENTION

It is, therefore, an object of the present invention to provide a method and system of fulfilling job requirements particularly suited for temporary labor market.

It is another object of the invention to provide computer-executable system and method of providing labor exchange services for job applicants and employers seeking qualified employees.

These and other objects of the invention are achieved through a provision of a system and method, which matches potential employees with potential employers in labor exchange, such as temporary labor exchange. The system operates through a network and a server, while communicating with a potential employee electronic device such as a cell phone, a smart phone, a tablet, a laptop and the like. The server also communicates with one or more computers of potential employer(s). Both the employer and employee can access the network using their respective electronic devices.

When creating an account with the network, a potential employee inputs his/her employment information comprising the potential employee's primary trade skill, secondary trade skill, trade certifications, licensing, years of experience at primary trade skill, time when the potential employee is available for a job, availability for traveling to the job for the potential employee, and a preferred method of contacting the potential employee and other requested information, such as for instance, address, dates of the last drug test, etc.

The potential employer generates a job listing information, including job description, required skills, certifications, licensing, expected duration of a job, location of the job, and offered compensation. The server compares the received employment information with received job information for all job listings that have been posted by all potential employers and generates a list of job listings of potential jobs for the potential employee based on the comparison. The system transfers to the potential employee's electronic communication device via the network, the list of job listing for the potential employee for display on the potential employee's electronic device. The potential employer receives a list of potential employees, whose employment information matches one or more criteria on the job posting.

Once the potential employee accepts the job position and the employer accepts the employee, the system notifies both the employee and the employer and generates the necessary paperwork for execution of an employment contract. The system can be particularly beneficial in a labor exchange where temporary labor force is required.

### BRIEF DESCRIPTION OF THE DRAWINGS

Reference will now be made to the drawings, wherein like parts are designated by like numerals, and wherein

FIG. 1 is a schematic view of the system of the present invention.

FIG. 2 is a schematic view of a log-in step according to the method of the present invention.

FIG. 3 is a schematic view of an account set-up step according to the instant method.

FIG. 4 is a schematic view of a main menu page of the system of the present invention.

FIG. 5 schematically illustrates application of a module for creating an “availability” portion of an employee profile.

FIG. 6 schematically illustrates application of a module for creating an “experience” portion of an employee profile.

FIG. 7 schematically illustrates application of a module for creating a “certification” portion of an employee profile.

FIG. 8 schematically illustrates application of a module for creating a “labor exchange pool.”

FIG. 9 schematically illustrates application of a module for creating an “open pool” database.

FIG. 10 schematically illustrates application of a module for creating a “closed pool” database.

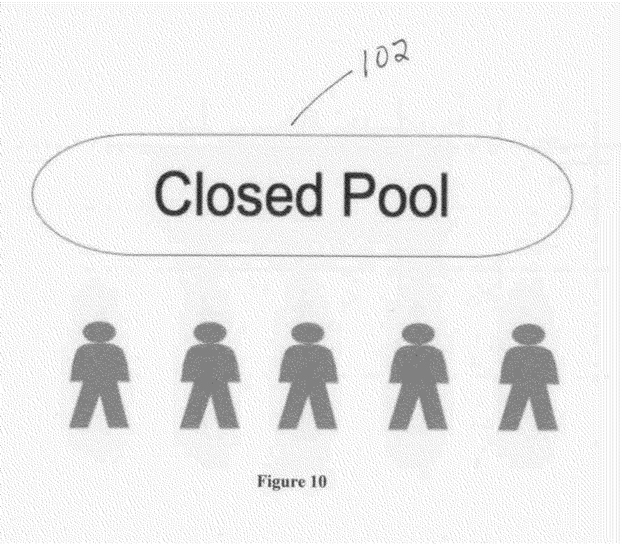

FIG. 11 schematically illustrates application of a “management” module.

FIG. 12 schematically illustrates application of a module of “contractor profiles.”

FIG. 13 schematically illustrates application of a module of “expanded contractor profile.”

FIG. 14 schematically illustrates application of a module of “job listings.”

FIG. 15 schematically illustrates application of a module of “expanded job listings.”

FIG. 16 schematically illustrates application of a module of “expanded job offer” available on a screen of a mobile communication device.

### DETAIL DESCRIPTION OF THE INVENTION

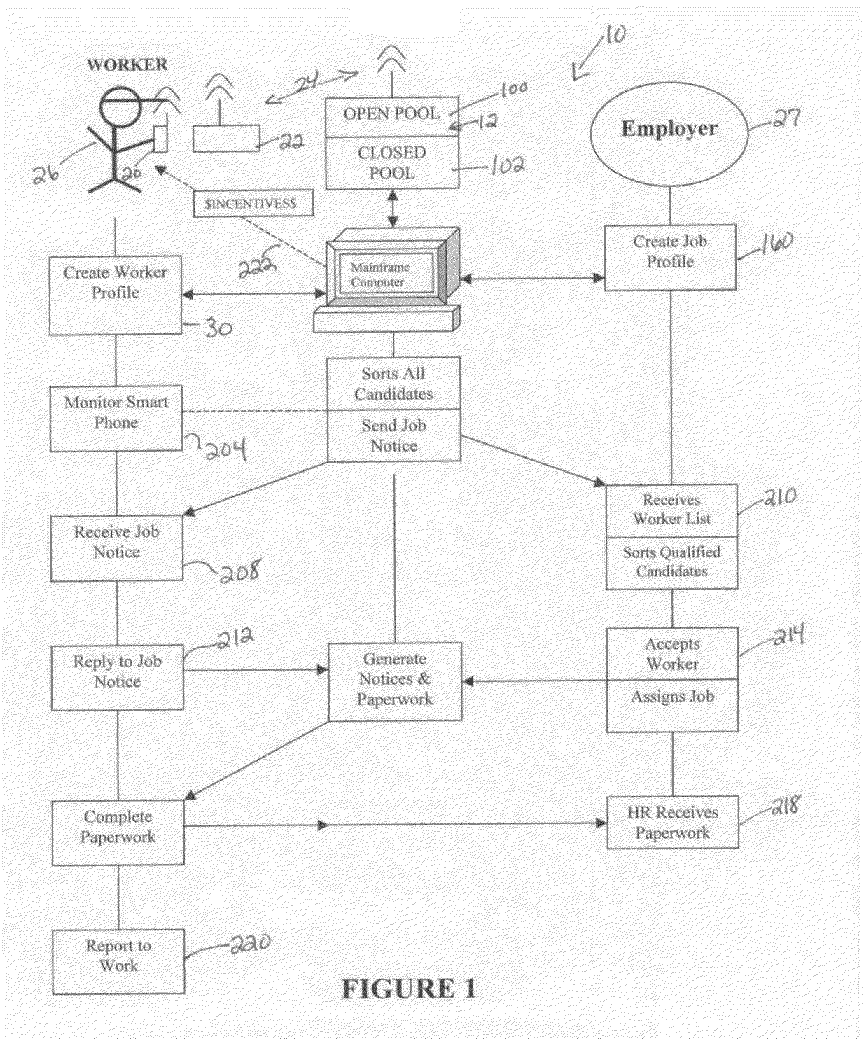

Turning now to the drawings in more detail, FIG. 1 schematically illustrates a conceptual diagram the system and method of fulfilling labor requirements 10 in accordance with an embodiment of the invention. Globally accessible database 12 is configured to store information essential for matching job applicants with available job positions, including information about qualified candidates, their locations, experience, education, certifications and other information important to an employer/contractor. Each applicant and job position is identified by a computer readable identifier unique for the applicant and employer. The database 12 is connected to a centralized server 14 accessed via a gateway or portal 16 that serves as a secure entry channel. Access to the database 12 is restricted by a security layer, such as a firewall and/or other access control systems.

A worker and an employer access the database using electronic communications devices such as handheld portable units 20 (cellular phones. smart phones, tablets and the like), or desktop/portable computers 22, or other devices capable of communicating via an open network, such as the Internet. The electronic communication devices 20 and 22 communicate with the server 14 through a bi-directional link 24. Each user is provided with a unique log-in identifier and password.

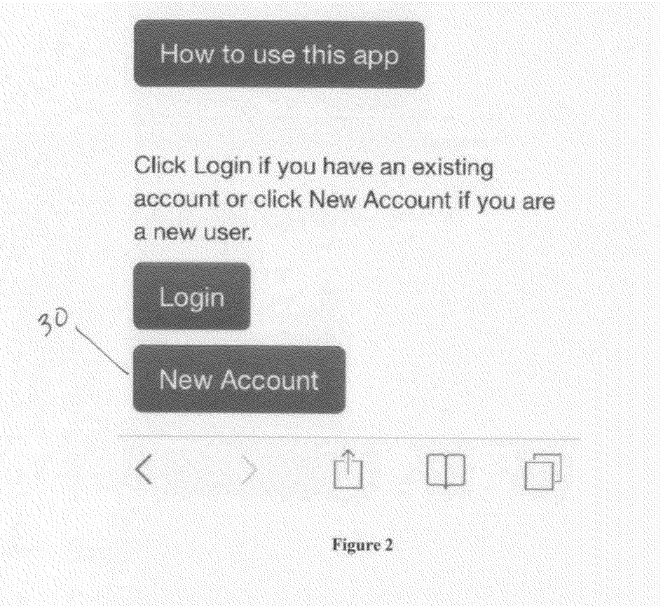

FIG. 2 illustrates a step of setting up a new account in the system 10. Both potential employee 26 and employer 27 are required to open a new account, which will allow them access to the database. A new employee 26 sets up a new user account by typing the URL address into the search engine on the handheld portable unit 20 or the computer 22. The user (the employee or the employer) creates a new account in a step 30 by first creating a user name and password.

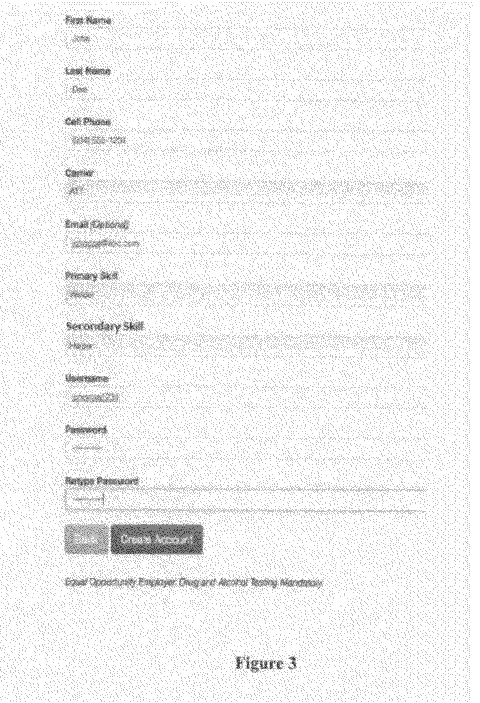

A first time user, an employee, is directed to create a new account following a series of prompts on the screen, as schematically shown in FIG. 3. The worker enters his/her name, telephone number, telephone carrier, email address, as well as the worker's “primary skill(s).” For example, the worker/potential job applicant John Doe can be a welder, a mason, lathe operator, a helper, etc. Together with the use name and password, the entered information allows the worker to create a new account.

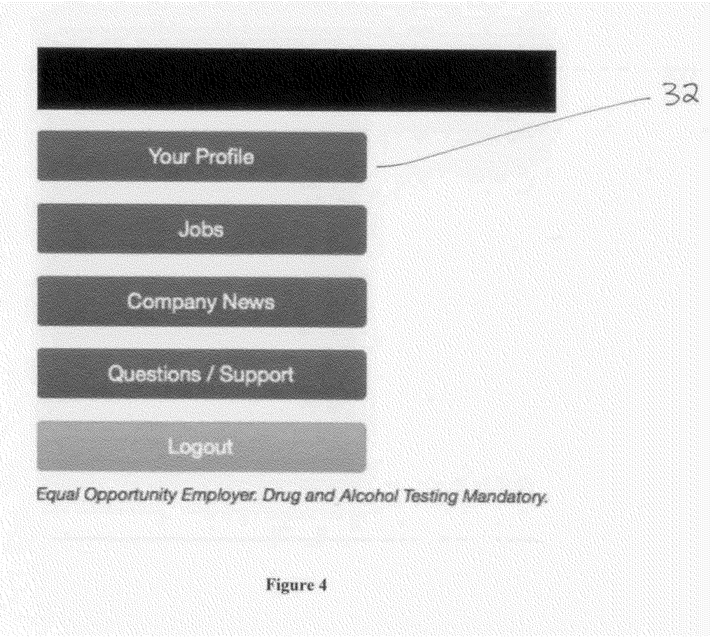

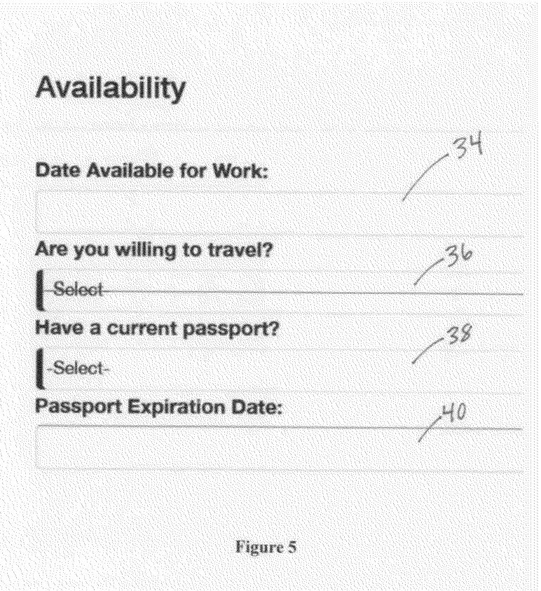

Once the initial profile is completed the worker is directed to the main menu schematically shown in FIG. 4. In that step, the worker can create a more detailed profile 32 by inputting more specific information about his/her skill sets. More specifically, when the user 26 clicks on “Your Profile” button, the system opens a screen schematically shown in FIG. 5. On that screen the worker 26 inputs information about his/her availability. A window 34 is provided for introducing the date or dates when the worker 26 is available for work. A window 36 allows the user 26 to choose whether the user is willing to travel or not and to what distances. A window 38 gives a choice of passport availability, and a window 40 allows the user to input information about the passport expiration date if the passport is available.

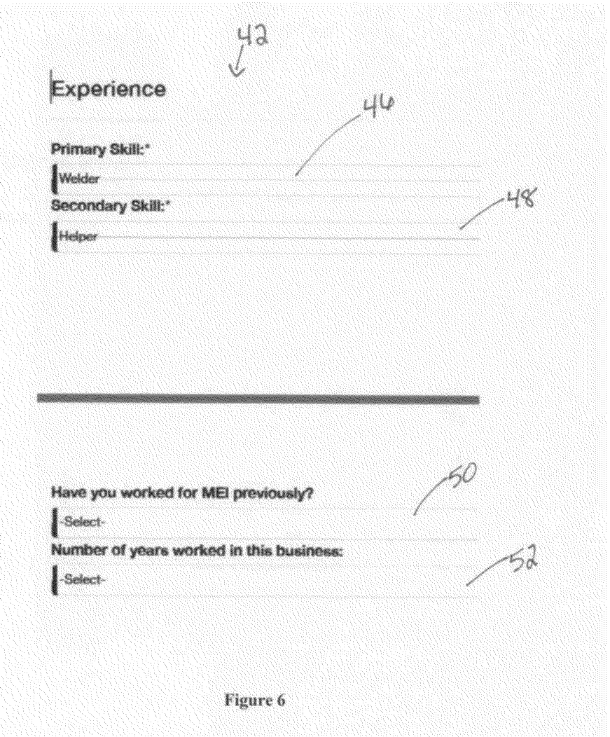

The “Experience” module of FIG. 6 is configured to receive information about the worker's primary skill (for instance a welder) in a window 46 and a secondary skill (for instance a helper”) in a window 48. The system 10 queries the user 26 whether he/she has previously worked for the company in a window and the number of years that the worker has worked in the business in window 52.

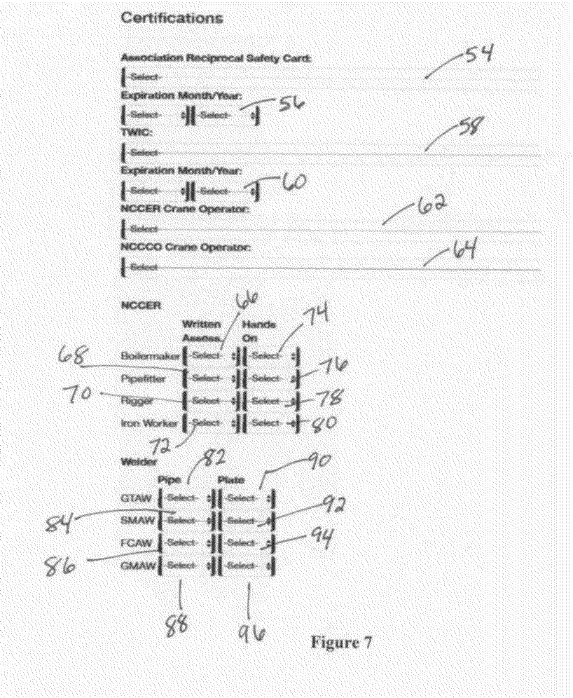

An important “Certifications” module schematically shown in FIG. 7 prompts the user 26 to provide information about the user's licenses, certifications, work permits, etc. A window 54 prompts the user to select the Association Reciprocal Safety Card, which is issued by Association Reciprocal Safety Councils (ARSC). The ARSC Councils develop and revise training programs that meet a significant portion of OSHA (Occupational Safety and safety Administration) requirements. The user is requested to enter the expiration date of the ARSC card in window 56.

If the job applicant works in the transportation industry, he/she is prompted to enter the worker's TWIC (Transportation Worker Identification Credential) card in window 58 and its expiration—in window 60. TWIC card is considered an important security measure ensuring that individuals who pose a threat to the national security do not gain unescorted access to secure areas of the nation's maritime transportation system.

Tradesmen often have a specialized certification, which is provided by the National Center for Construction Education and Research (NCCER). This non-profit company developed many standardized training and credentialing programs for the industry. NCCER provides curricula for more than 70 craft areas and a complete series of more than 70 assessments offered in over 4,000 NCCER-accredited training and assessment locations across the United States.

Those possessing NCCER certification are invited to enter the information in a window 62.

The National Commission for Certification of Crane Operators (NCCCO) has developed standards for safe crane operation used in the general industry and construction. NCCCO provide an independent assessment of knowledge and skills of crane operators in order to increase safety, reduce workplace risk, and improve performance of workers. If the worker 26 is a crane operator and has received a certification from NCCCO, the worker is invited to enter the certification information in window 64.

It will be understood that other certifications and licensing data may be entered in the “Certifications” module depending on the worker's specialty. For instance, NCCER certification of a boilermaker can be entered in window 66, pipefitter—in window 68, rigger—in window 70, iron worker—in window 72, etc. The system also prompts the worker to enter information about the worker's hands-on experience in various fields in windows 74-80.

If the worker 26 is a welder, he/she may possess other qualification, such as experience in gas tungsten arc welding (GTAW), shielded metal arc welding (SMAW), flux-cored arc welding (FCAW), or gas-metal arc welding (GMAW). Information about these qualifications can be entered in windows 82-88, respectively. Experience in plate welding can be also entered in windows 90-96.

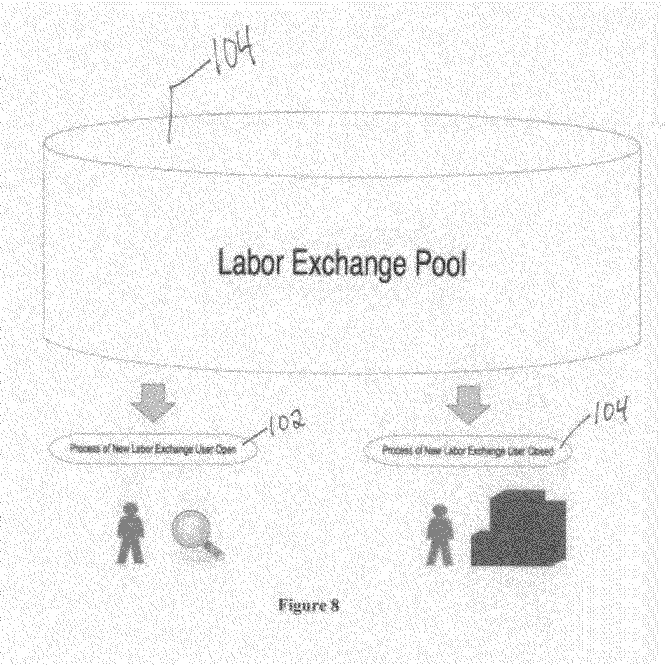

Once the mobile profile is complete, the worker's credentials and employment will be managed through one of two management portals: Open Pool 100 and Closed Pool 102. The Open Pool and the Closed Pool constitute a Labor Exchange Pool 104. As can be seen in the schematic illustration in FIG. 8, the Closed Pool 104 is closely related to company information.

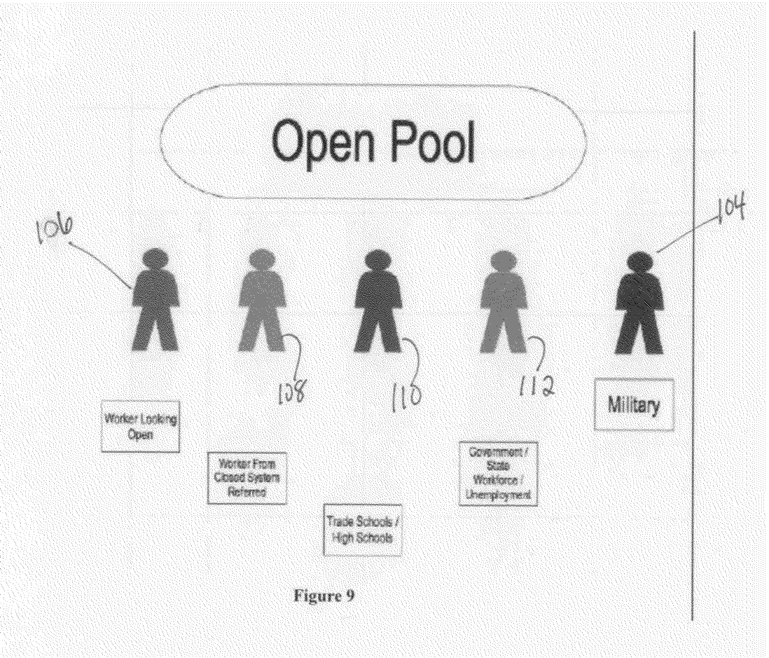

Open Pool 100 shown in FIG. 9 includes employee profiles and is open for selection by any member who had elected to create a new account and introduced his profile in the system 10. The Open Pool 100 is composed of workers looking for work 106, workers referred from the Closed Pool 108, trade school and/or high school graduates 110, government/state/unemployed workers 112, former military 114, etc.

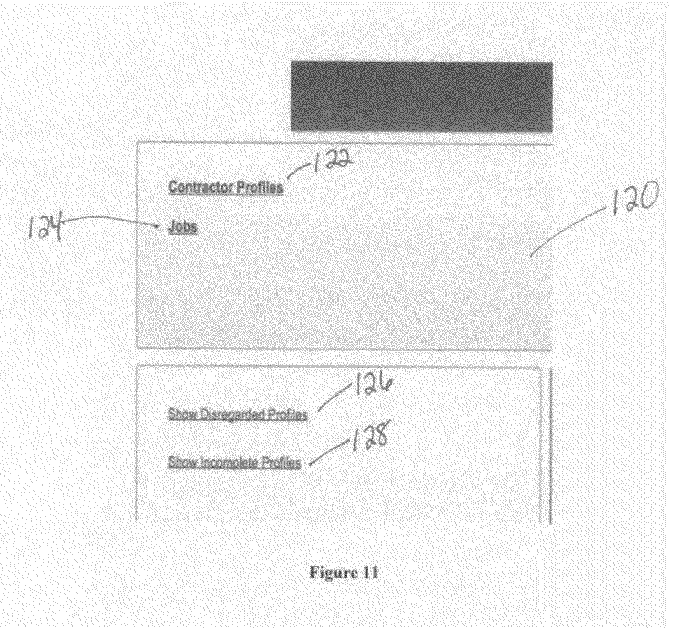

The Closed Pool 102 database is created to include workers from a company employee roster, the company human resources departments, and the like. The Closed Pool is accessible only to workers and employers who are members of a Closed Management Portal. FIG. 11 schematically illustrates the Management Nodule 120, which allows the employer to create Contractor Profile 122, upload information about available Job positions 124. Options of showing disregarded profiles is accomplished in step 126, and an option of showing incomplete profiles can be accomplished in step 128.

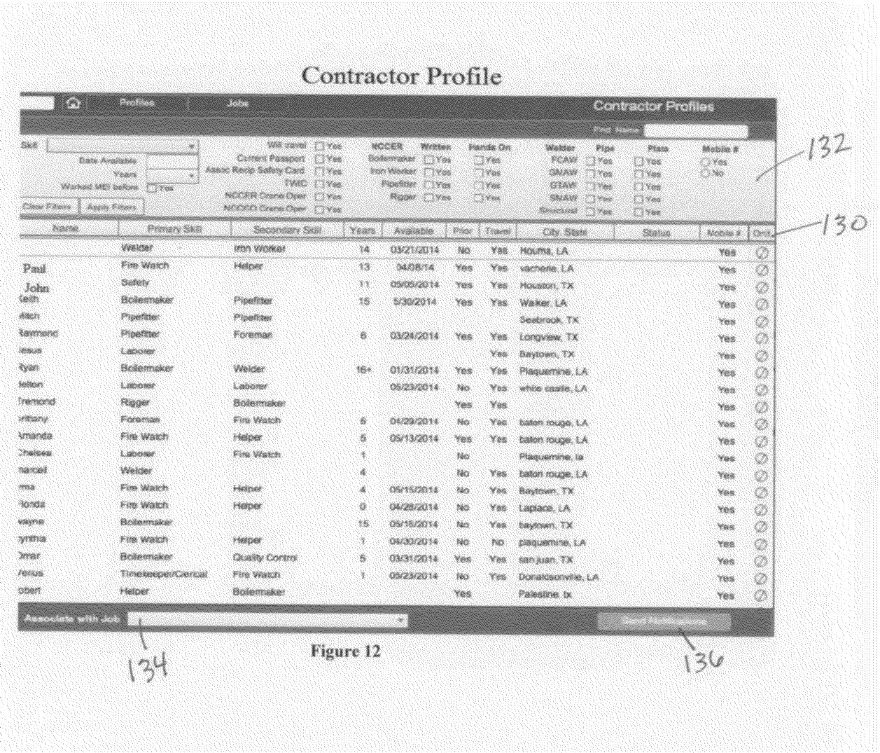

FIG. 12 illustrates a screen of Contractor Profiles visible to an employer 27. The screen is divided into rows and columns containing a variety of information processed by the computing processor 14 and extracted from the worker's profiles. Names, addresses, certifications and availability of the worker as entered at the Profile Module are sorted depending on the employer's criteria. For instance, the first line in the table is shown to be Paul, whose primary skill is a welder, and iron worker—as secondary. Mr. Acosta is shown to have 14 years of experience, availability from Mar. 21, 2014. This candidate has never worked for the inquiring company and is willing to travel from his home in Houma, La. Mr. Acosta has a mobile phone 20 and can be contacted. The last column “Omit” 130 can be used by the potential employer to eliminate candidates, whose qualifications do not match the required skills, for instance number of years of experience, willingness to travel, etc.

A portion of the screen 132 above the potential employee's names is used for other profile information, such as certifications, licensing, as described above in the “Certifications,” “Experience,” and “Availability” modules. On the bottom of the screen, the employer 27 can view a note space “Associate with Job,” and “Send Notification.” The employer can click the button 136 and a notification of the willingness of the employer to hire the prospective employee, for instance Mr. Acosta, is sent via the network 24 to the employee's communication device, such as a smart phone, a laptop, a tablet, etc.

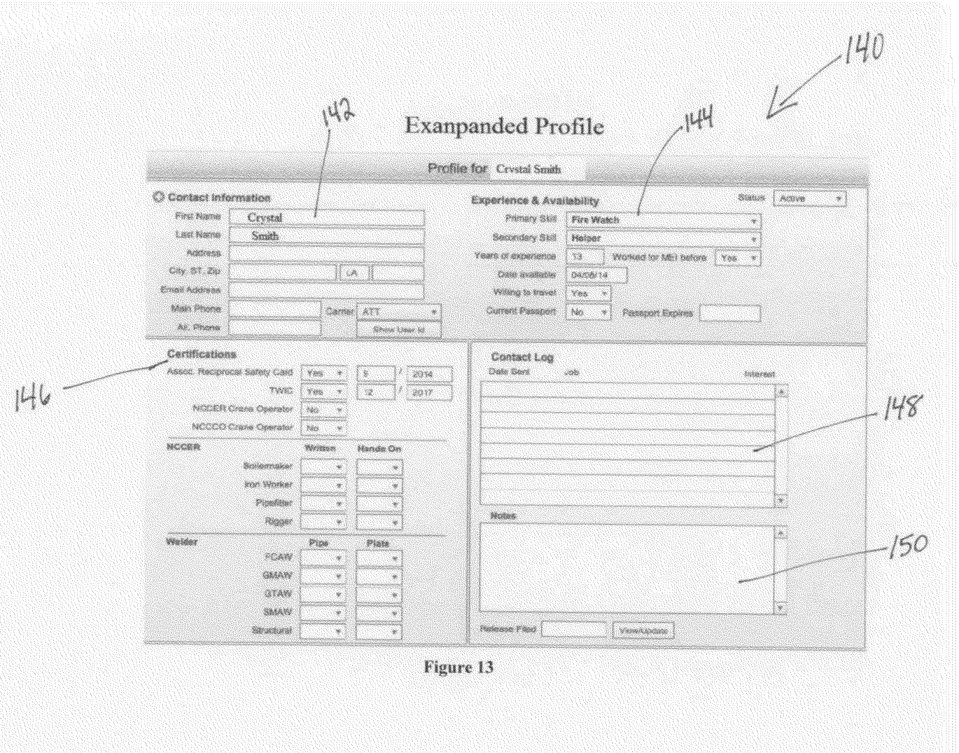

If the employer 27 wishes to obtain more information about the potential contractor, the employer 27 can access a module “Expanded Profile” 140 schematically shown in FIG. 13. The module 140 provides full profile information on each worker 26, member of the labor exchange system 10. In the exemplary view of FIG. 13, a potential employee Crystal Smith's profile is illustrated. As can be seen in the drawing, Ms. Adams' contact information, including address, email address, telephone number and the cell phone carrier are shown in a block 142 of the module. Ms. Adams' experience and availability are seen in block 144 of the module, certifications—in block 146. A contact Log is shown in block 148, where the system user can input the date when Ms. Adams was contacted, the offered job and whether Ms. Adams expressed interest in the employment offer. Field 150 is reserved for any notes that the user wishes to make regarding Ms. Adams' employment.

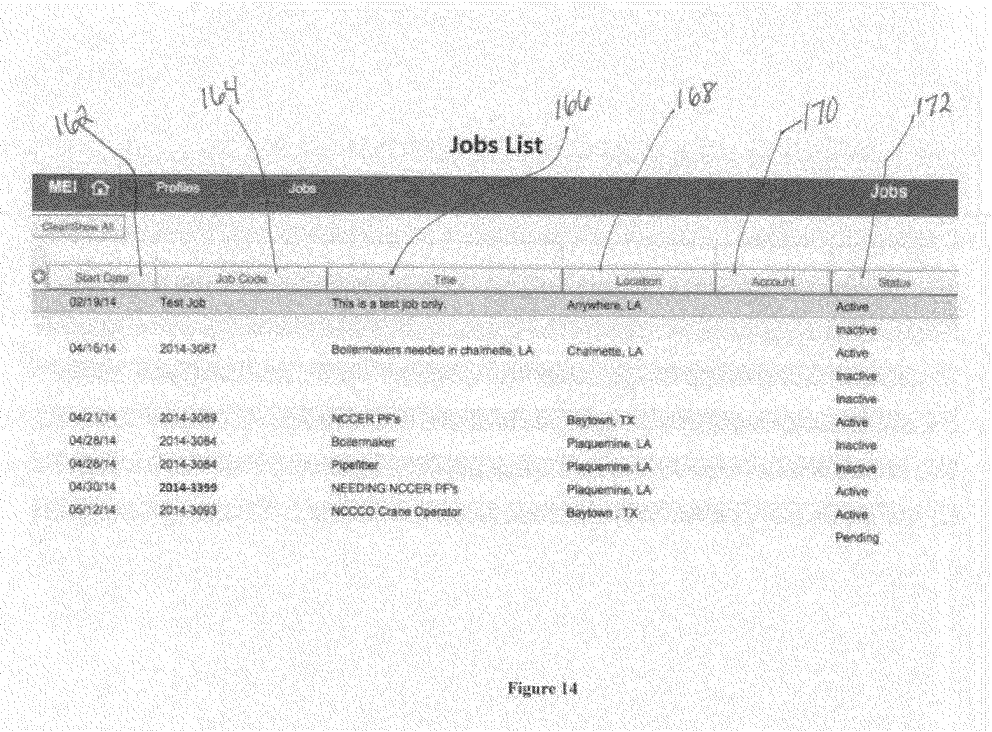

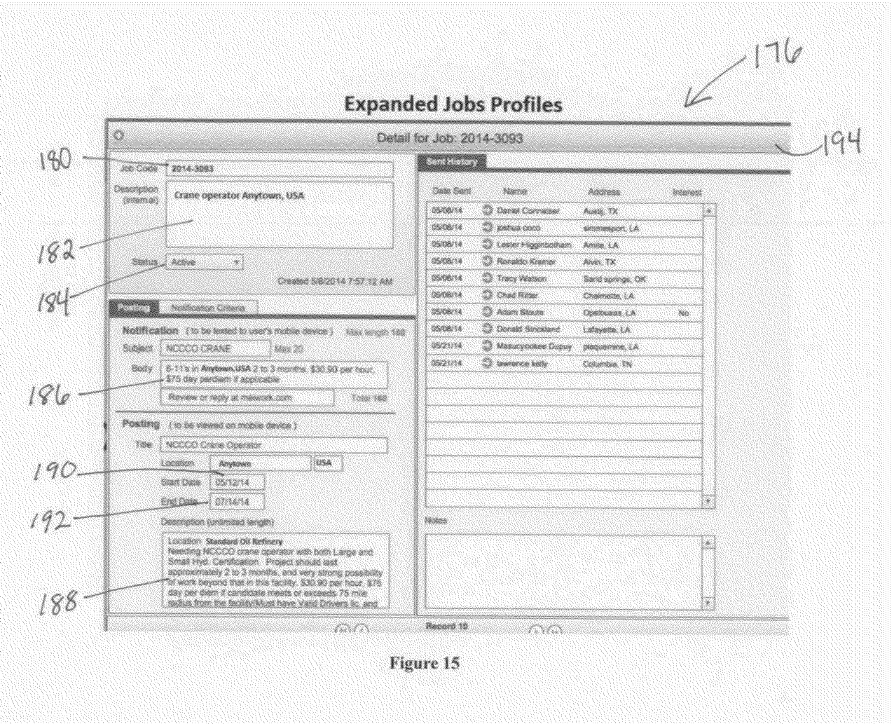

The system 10 allows the worker 26 to view all available job postings using the module 160 schematically illustrated in FIG. 14. The module 160 can be viewed on a screen of any communication device that the worker has. In the exemplary illustration of FIG. 14, the Job List includes the columns for “Start Date” 162, “Job Code” 164, “Title” of the job 166, “location of the Job” 168, “Account Holder's Name” 170, and “Status” (active or inactive) 172. Should one particular job on the Job List interests the worker, he/she can initiate “Expanded Job Profiles” module 176, an example of which is shown in FIG. 15.

The module 176 allows the user to obtain more information about a particular job posting. In the example of FIG. 15, the Job Code of the posting is 2014-3093, which can be seen in window 180, with the description of the job “Operators Exxon Baytown Texas” appearing in window 182. Status of the posting is seen in window 184 (“active”) and the time the job opening was posted is shown in the same block of data.

The expanded profile of this job posting informs the user how the information of acceptance will be communicated; in this case, by texting to the user's mobile device. The data displayed in the “Body” window 186 is more specific—it informs that the job involves a 6-day work week, each work day lasting 11 hours (“6-1's”), location of the job “Baytown, Tex.”), the duration of the contract (“2-3 months”), salary (“$30.90 per hour”) and per diem of $75 if applicable. The prospective employee is advised to review and respond through the network of system 10.

An even more detailed job posting is displayed in a window 188, providing further information about a possibility of the contract being extended, eligibility for per diem payments, and more specific data about the job (“Needing NCCCO crane operator with both Large and Small Hyd. Certification”). The start and end dates are displayed in windows 190 and 192.

The right side of the screen shot illustrated in FIG. 15 contains “Sent History” module 194 that has a list of persons, to whom this particular posting has been sent, including the date, name of recipient and location of the recipient. The employer can easily keep track of the persons interested in the position. In this example, at least one persons (Adam Stoute) relied that he was not interested in the contract.

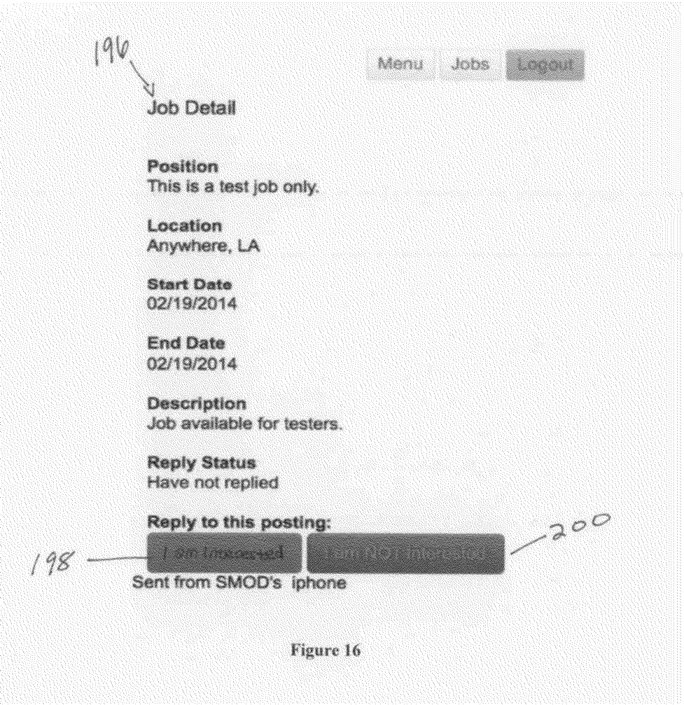

Potential contractors utilize the module 194 by accessing expanded Job Detail acceptance module 196 schematically shown in FIG. 16. The Job Detail Acceptance module 196 comprises basic data about a job posting and also a means for communicating the worker's acceptance or refusal of the job offer. If the worker is interested the worker clicks on a button 198, if no interest—on a button 200. In any case, this interaction is communicated through the system 10 and is entered into the open or closed database.

Returning to the flowchart of FIG. 1, the method of the present invention is seen roughly divided into steps performed by the worker 26 and the steps performed by the employer 27. On the worker's side, the worker creates the profile discussed above and uploads it to the mainframe computer 14. The employer 27 similarly creates a job profile and uploads it to the mainframe computer 14. The software downloaded into the computer 14 sorts all candidates in a step 202 based on a variety of criteria, including experience, certifications, availability for travel, etc. The application that the worker downloads into his/her communication device at the sign up stage monitors any messages and job postings in step 204. If the system 10 detects a possible match between the job applicants and the job postings, a “Send Job Notice” is generated in a step 206.

The worker 26 receives the job notice on the worker's designated communication device in a step 208. On the employer's side, the employer receives a list of all potential contractors that match one or more criteria within the job posting, in a step 210. The employer sorts the data received in the step 210 and identifies likely candidates to fill the job opening. Once the employer identified the candidates matching the employer requirements, the employer communicates the list of matching candidates to the system 10.

On the worker's side, the worker 26 replies to the job posting, through the system 10, in a step 212, while communicating the worker's readiness to accept the job offer. The employer makes the final selection and accepts the worker in a step 214, assigning the posted job to that particular worker. The system 10 generates the necessary notice of the job acceptance and the employer accepting one or more employees from the list generated by the server 14 of all matching potential employees. This step is schematically illustrated as step 216 in FIG. 1. The paperwork includes an employment contract for the worker 26 and the employer 27 to sign.

The paperwork is forwarded to the worker, who is required to complete the documents, sign the contract and send it directly to the human resources department (if available) of the employer 27 in a step 218. Finally, the worker reports to work in a step 220.

The system of the present invention contemplates an optional step of offering incentives to potential contractors who sign up with the administrator of the system 10. As shown in FIG. 1, once the worker creates and submits profile to the processor 14, the processor may be programmed to generate a pre-determined type of incentive, for instance a gift card to a merchant, a restaurant, or an attraction. The incentive is forwarded to the worker in a step 222.

Optionally, the system 10 makes available direct marketing slots and rewards on app/smart phone for companies to market and provide special deals to the labor exchange worker/user. These incentives come in the form of offers, discounts, free trials etc. This unique aspect of this part of the system gives the worker/user motivation to check and interact with the system rather than just letting it remain idle until he/she is looking for a job. This is also the perfect platform for companies to advertise and promote offers that cater directly to the industrial workforce.

The system of the present invention provides a means for a single company to create its own social network from which to draw for hiring purposes. Any company can create an open pool and a closed pool of prospective employees that can be called upon for a specific temporary project. The company can easily track the contractor's past employment with the company or past employment with other members of the labor exchange network. When compared to known methods of matching employees to a job request having minimum qualifications through computer computations, the instant system is capable of matching job needs of various industrial companies with the available workforce by building a conduit by which potential employees from trade schools and the like can find their way to jobs that meet their qualifications, i.e. welding certifications etc.

This system uses the databases from various contractors to find people in the database that will fill a particular job. While it is envisioned that this system will be particularly beneficial in a temporary labor market it is within the scope of the invention to create databases for other types of employment scenarios.

The Open Pool database is accessible to any member of the network, while the Closed Pool database can be accessible only by the specific employer if the employer wishes to maintain the exclusive labor pool. The system of this invention makes it easier for a company to prepare bids by allowing the company to better estimate availability of temporary workers, their pay, the cost of daily allowances and the like. The employer will also be able to receive acceptance from the temporary workers for a job that may last only several months.

Traditionally, the task of assembling a temporary team is costly and time consuming. Often times it takes many calls and emails to find out whether a particular welder, pipefitter, fabricator, etc. is available for a certain period. The system of this invention significantly streamlines the process by allowing direct communication between the company and the potential employees. Similarly, a potential employee, a member of the network of the present invention can readily access available job postings knowing that his/her hard-earned certifications and licenses will be known to a potential employer.

It is envisioned that the Profile module may include other queries vital to a particular employer, such as for instance, the date of the most recent drug test, the level of security clearance and the like. Many other changes and modifications can be made in the present invention without departing from the spirit thereof. I, therefore pray that my rights to the present invention be limited only by the scope of the appended claims.

I claim:

1. A method for matching a potential employee with a potential employer using a potential employee's electronic communication device and a potential employer's computer connected to a server via a network, comprising the steps of:
entering employment information at the employee's electronic communication device comprising potential employee's primary trade skill, secondary trade skill, trade certifications, licensing, years of experience at primary trade skill, time when the potential employee is available for a job, availability for traveling to the job for the potential employee, and a preferred method of contacting the potential employee;
transferring to said server via said network said employment information for the potential employee;
at the potential employer's computer, entering information regarding the job opening, comprising potential employer's job description, required skills, certifications, licensing, expected duration of a job, location of the job, and offered salary;
transferring to said server via said network the job opening information to post a job listing;
comparing at said server the received potential employee's employment information with the job opening information for all job listings that have been posted by all potential employers;
generating at said server a list of job listings of potential jobs for the potential employee based on the comparison;
generating at said server a list of potential employees based on the comparison;
transferring to said potential employee's electronic communication device the list of job openings; and
transferring to said potential employer's computer the list of potential employees.

2. The method of claim 1, comprising a step of generating at said server a job acceptance notice for the potential employer in response to receiving an indication that the potential employees are available to accept a job offer from the job listings.

3. The method of claim 2, comprising a step of generating a notice to the potential employee of the potential employer accepting the potential employee and generating a job acceptance contract for the potential employee and the potential employer.

4. The method of claim 1, wherein the potential employee's electronic communication device comprises a cellular, a smart phone, a tablet, or a computer.

5. The method of claim 1, comprising a step of generating at said server an open pool database accessible to all network users.

6. The method of claim 5, wherein said open pool database comprises employment information for all potential employees within the network and job listings of all potential employers.

7. The method of claim 1, comprising a step of receiving at said server a request from a potential employer for restricted access to potential employer-generated list of job openings and employment information of potential employees.

8. The method of claim 7, comprising a step of generating at said sever a closed pool database accessible to selected potential employees in response to the potential employer's request for restricted access.

9. The method of claim 1, comprising a step of generating an incentive reward in response to receiving at said server via said network said employment information from the potential employee.

10. The method of claim 1, wherein said potential employee is a temporary employee.

11. A job matching and job placement system for matching a potential employee with a potential employer over a network, the system comprising:
a network;
a server;
a potential employee electronic communication device capable of accessing the server via the network;
a potential employer computer capable of receiving and communicating to said server, via said network, position information regarding a job opening of the potential employer; and
wherein said server is configured to: receive from the potential employee employment information comprising the potential employee's primary trade skill, secondary trade skill, trade certifications, licensing, years of experience at primary trade skill, time when the potential employee is available for a job, availability for traveling to the job for the potential employee, and a preferred method of contacting the potential employee, said server is configured to: receive from the potential employer position information comprising potential employer's job description, required skills, certifications, licensing, expected duration of a job, location of the job, and offered salary, said server comparing the received employment information with received position information for all job listings that have been posted by all potential employers, said server is configured to generate a list of job listings of potential jobs for the potential employee based on the comparison and to transfer to the potential employee's electronic communication device via said network, the list of job listing for the potential employee for display on the potential employee's electronic device.

12. The system of claim 11, wherein said server is configured to transfer to the potential employer's computer via the network, employment information of all potential employees matching one or more criteria of the received position information for display on the potential employer's computer.

13. The system of claim 11, wherein the potential employee is a temporary employee.

14. The system of claim 11, wherein the position information comprises temporary job positions.

15. The system of claim 11, wherein the server is configured to generate a job acceptance notice for the potential employer in response to receiving an indication that the potential employees are available to accept a job offer from the job listings.

16. The system of claim 15, wherein the server is configured to generate a notice to the potential employee of the potential employer having accepted the potential employee and to generate a job acceptance contract for the potential employee and the potential employer.

17. The system of claim 11, wherein the potential employee's electronic communication device comprises a cellular phone, a smart phone, a tablet, or a computer.

18. The system of claim 11, wherein the server is configured to generate an open pool database accessible to all network users.

19. The system of claim 18, wherein said open pool database comprises employment information for all potential employees within the network and job listings of all potential employers.

20. The system of claim 1, wherein the server is configured to receive a request from a potential employer for restricted access to potential employer-generated list of job openings and employment information of potential employees.

21. The system of claim 20, wherein the server is configured to generate a closed pool database accessible to selected potential employees in response to the potential employer's request for restricted access.

22. The system of claim 11, wherein the server is configured to generate an incentive reward in response to receiving at said server via said network said employment information from the potential employee.

23. A computer-readable medium bearing instructions for matching a potential employee with a potential employer over a network, said instructions being arranged to cause one or more processors upon execution thereof to perform the steps of:
entering employment information at the employee's electronic communication device comprising potential employee's primary trade skill, secondary trade skill, trade certifications, licensing, years of experience at primary trade skill, time when the potential employee is available for a job, availability for traveling to the job for the potential employee, and a preferred method of contacting the potential employee;
transferring to said server via said network said employment information for the potential employee;
at the potential employer's computer, entering information regarding the job opening, comprising potential employer's job description, required skills, certifications, licensing, expected duration of a job, location of the job, and offered salary;
transferring to said server via said network the job opening information to post a job listing;
comparing at said server, the received potential employee's employment information with the job opening information for all job listings that have been posted by all potential employers;
generating at said server a list of job listings of potential jobs for the potential employee based on the comparison;
generating at said server a list of potential employees based on the comparison;
transferring to said potential employee's electronic communication device the list of job openings; and
transferring to said potential employer's computer the list of potential employees.

24. The computer-readable medium of claim 23, capable of causing one or more processors upon execution thereof to perform the steps of generating an open pool database and a closed pool database.

25. The computer-readable medium of claim 24, wherein the open pool database comprises employment information for all potential employees within the network and job listings of all potential employers.

26. The computer-readable medium of claim 24, capable of causing one or more processors upon execution thereof to perform the steps of receiving a request from a potential employer for restricted access to potential employer-generated list of job openings and employment information of potential employees.

27. The computer-readable medium of claim 26, capable of causing one or more processors upon execution thereof to perform the steps of generating a closed pool database accessible to selected potential employees in response to the potential employer's request for restricted access.

28. The computer-readable medium of claim 23, capable of causing one or more processors upon execution thereof to perform the steps of generating an incentive reward in response to receiving the employment information from the potential employee.
